(19) United States
(12) Patent Application Publication
(10) Pub. No.: US 2016/0107182 A1
(43) Pub. Date: Apr. 21, 2016

(54) DEVICE FOR DISPENSING LIQUID WITH HIGH PRECISION

(71) Applicant: Yibing Li, San Francisco, CA (US)

(72) Inventor: Yibing Li, San Francisco, CA (US)

(21) Appl. No.: 14/877,951

(22) Filed: Oct. 8, 2015

Related U.S. Application Data
(63) Continuation of application No. 14/057,327, filed on Oct. 18, 2013, now abandoned.

(51) Int. Cl. B05B 11/02; G01F 11/02; B05B 12/00

(52) U.S. Cl. CPC B05B 11/02; B05B 12/002; G01F 11/027

(57) ABSTRACT

A liquid dispensing device mounted on a liquid container comprises a lower-plunger, an upper-plunger, a syringe, a rotating-cap and a hollow stud-bolt, combined such that the syringe is secured at the opening of the liquid container and the rotating-cap is set at the proximal end of the syringe. The rotating-cap runs on the hollow stud-bolt to set a dispense volume. The lower-plunger and upper-plunger are facing each other inside the syringe. The lower-plunger that passes through the distal end of the syringe is pushed into the syringe and when the lower-plunger is pulled back, a precise volume of liquid is trapped between the lower-plunger and the upper-plunger inside the syringe and dissipated from a dispensing outlet on the barrel of the syringe.

### FIELD OF THE INVENTION

The present invention offers a liquid dosing and dispensing device. Specifically, what is invented is a liquid delivery device which provides a precise and adjustable volume control for direct, convenient liquid delivery.

### BACKGROUND OF THE INVENTION

Transfer of liquids is an ancient art and an integral part of human daily life. However, there is room for improving the mechanisms of this activity with respect to quantity, efficiency, safety, accuracy, environmental soundness, and cost-effectiveness, to meet many purposes in different aspects of human life.

For most purposes in society at large, transfer of liquids is still semi- or non-quantitative. However, in scientific research, precision and reproducibility are critical; there are developed methods and techniques to perform volume-controlled transfer of liquid. Equipment and tools such as graduated cylinders and syringes are widely used to transfer relatively large quantities of liquid (>50 milliliters). Pipettes (from ½ milliliter to 50 milliliter) and pipette tips (from ½ microliter up to 1 milliliter) are most commonly used tools when dealing with smaller volumes. Although they are efficient and relatively accurate, these pipettes and tips are not cost-effective and environmentally sound because they are often used only once. Following their use, they become medical and research waste and are usually burned for safety reasons. A less popular device, the bottle top dispenser (U.S. Pat. No. 3,940,027), can efficiently transfer up to 10 ml liquid at a given time. However, it lacks accuracy, in particular when dispensing liquids of higher viscosity or containing high amounts of dissolved gases and therefore it is not as commonly used as aforementioned laboratory equipment and devices. When dealing with large volumes (high-throughput), or when high accuracy is required, one can also use liquid handling robots that use robotics to control the transfer of liquid. In this case, the liquid transfer becomes expensive.

Due to their various shortcomings, the aforementioned methods, devices, and equipment have not become popular for general uses by the society at large. Nevertheless, in the future, accurate dispensing will become an increasingly desirable part of our daily life. For example, one might find it very useful to consume the same amount of liquid nutrients or nutrient supplements every day in order to control caloric intake. For a similar reason, one might want to irrigate plants and vegetables with an exact volume of water and nutrients periodically to control their growth. For mixing alcoholic cocktails (U.S. Pat. No. 4,243,157), one might want to have an instrument with better consistency, more accuracy, and greater flexibility to serve customers and to satisfy their individual tastes. For medicine and medications, the best therapeutic effects for certain medications achieved by dosing according to the body weight. Examples of such medications include, but are not limited to, the chemotherapeutics and Coumadin. The treatment effect as well as patient safety is better achieved by the adjustment of the dosages based on the body weight. In this case, medicines in liquid form do have the advantage over medicines delivered by solid pills. Therefore, a liquid dosing device that provides accurate volume control will be essential in order to achieve the therapeutic goal. In cosmetics, such as with hair dyes, if such a device is part of the product, the dye solutions can be aliquoted exactly for the individualized and repetitive use in order to achieve the desired effects. Given these and many more potential uses, it is very desirable to have not only precise but also flexible liquid dispensers that are also easy to operate and efficient to use. The individual aliquots may range from very small volumes to quite large volumes, i.e. from less than one milliliter up to 10 to 20 milliliter.

The previous submission of this invention in published U.S. patent application Ser. No. 14/057,327 is depicted in FIG. 1 (from left to right: sectional, front and back views of the dispensing device). In the current submission, the Syringe x14 is modified to strengthen its structure and to improve its functionality, while the Lower Plunger x01 and the Upper Plunger x06 are unchanged. Also, in the previous submission, there was a thread on the external wall of the Syringe x14, engaged by a Center Dial Wheel x21 to shift the syringe to set a specific dispensing volume every time the dispensing volume is changed. As a result, the opening x35 on the Cylinder Part2 x33 was adapted to an oval shape to accommodate the Dispensing Outlet x16 on the syringe that shifts its position. Also the thread on the external wall weakens the structure of the Syringe x14. In addition shifting of the Dispensing Outlet x16 made the process of collecting dispensed liquid difficult as well. In the current submission, the syringe housing (x21) is modified to be stably restrained to the opening of the liquid container, eliminating the need for an outside shell (therefore Cylinder Part1 x25, Part2 x33 and Part3 x38 are all deleted). To adjust the dispensing volume a rotating-cap 41 (FIG. 6) and a hollow stud-bolt 51 (FIG. 7) are placed at the proximal end of the syringe 21 (FIG. 5). The hollow stud-bolt is inserted in the center of the rotating-cap that engages the external thread on the hollow stud-bolt. As the rotating-cap turns the hollow stud-bolt shifts axially and as a result, the dispensing volume is changed. Overall, the device in previous submission works well but the modified device in the current submission is simpler and stronger in structure, and is easier to make.

### SUMMARY OF THE INVENTION

The current invention provides a liquid dosing and dispensing device comprising a lower-plunger, an upper-plunger, a syringe, a rotating-cap and a hollow stud-bolt combined to extract and dispense liquid with high precision.

In one use the liquid dispensing device is mounted at the base of a liquid container. The liquid container could be a bottle, a bag, a bucket or any apparatus that holds liquid. The liquid inside the container could be water, a solution that contains one or more chemicals, or any chemical compounds that is in fluid.

In another use the liquid dispensing device delivers the liquid directly from a donor container to a recipient container without requiring conventional liquid transferring tools, such as a pipette, a pipette tip or a graduated cylinder, etc. The liquid dispensing device is mounted at the opening of the donor container, has direct contact with the liquid in the container and is designed for the repetitive use. Therefore, the device is not disposable and does not generate plastic waste.

In another use the liquid dispensing device delivers the liquid of higher viscosity or containing high amounts of dissolved gases with high precision. In these applications, liquid delivery methods employing pipettes or pipette tips have difficulties to achieve precision.

In each use the liquid dispensing device delivers the liquid with precise volume and a great range of adjustability. The precision and adjustability of the delivery volume by the liquid dispensing device is achieved by the rotating-cap with fine threading to adjust the axial position of the hollow stud-bolt and to change the relative position of the upper-plunger and the syringe.

In the current invention, the lower-plunger of the liquid dispensing device is different from a conventional plunger. In the conventional plunger, an arm is secured and attached to the rear of the plunger head while the front of the plunger head is facing liquid and is used for propelling liquid. In an ordinary use, the user pushes the arm of the conventional plunger forward to propel the liquid toward the distal end of the syringe where it has an opening or it connects to a needle through a tip on the syringe. In the current invention the arm of the lower-plunger is attached and secured to the front of the plunger that is used to propel the liquid. The user pulls the arm of the lower-plunger forward to push the liquid towards a dispensing outlet that is located on the barrel of the syringe. To prevent the leak of liquid from the joints between the end of arm and the head of the low-plunger, the arm is provided with a threaded stem at the end that passes through the plunger head and is run by a nut on its back. The nut tightens the joints and seals the two surfaces.

In the current invention, the upper-plunger of the liquid dispensing device is different structurally from a conventional plunger. The upper-plunger has a hole at the center and the upper-plunger arm is hollow as well. The central hole allows the arm of the lower-plunger to pass through the upper plunger. Another novel feature of the upper-plunger in the current invention ensures a water tight seal at its periphery as well as on the edges of the center hole where the arm of the lower-plunger passes. This is achieved by employing plunger head that is made of pliable material to form a portion of wall at the central hole of the upper-plunger.

In the current invention, the lower-plunger and the upper-plunger are arranged inside the syringe such that the faces of both plungers are aligned and coordinately extract and expel liquid from the syringe.

Also in the current invention, the syringe of the liquid dispensing device has several novel features that are not present in a conventional syringe. The conventional syringe has a tip that is located distal to the plunger and serves as a flow outlet. In the current invention the dispensing outlet is on the barrel of the syringe. The distal end of the syringe in the current invention contains a central hole to allow the arms of both upper-plunger and lower-plunger to pass through. On the cylindrical surface of the syringe in the current invention there is an expanding ring used to constrain the device to the neck of a bottle. The central hole on the proximal end of the syringe contains a guide slot to host the protruding block from the upper-plunger and several circular columns and circular spaces on the proximal end of the syringe to hold and house the hollow stud-bolt and two dial-wheels, etc.

### BRIEF DESCRIPTION OF THE DRAWINGS

FIG. 1 presents from left to right: a sectional view, front and back views of the dispensing device in the previous submission (U.S. patent application Ser. No. 14/057,327).

FIG. 2 contains a sectional view on the left and a projected view on the right of the assembly of the lower-plunger.

FIG. 3 has several panels, a sectional view on the left panel, a projected view and a detailed view on the top-right and bottom-right panels, respectively, to depict the assembly of the upper-plunger.

The FIG. 4 illustrates the arrangement between the lower-plunger assembly and the upper-plunger assembly.

In FIG. 5, the two top panels are projected views of the syringe, the bottom-left panel is a front view and the bottom-right is a sectional view of the same object.

FIG. 6 shows schematics of the rotating-cap. A projected view is in the top panel, and front and sectional views are in the bottom-left and bottom-right panels, respectively.

FIG. 7 shows schematics of the hollow stud-bolt (top panels) and the peg-wheel (bottom panels). In the top panels from left to right, they are front, sectional and two projected views of the hollow stud-bolt. In the bottom panels from left to right, they are a front view and two projected views of the peg-wheel.

FIG. 8 shows schematics of several miscellaneous components. The gear is identified as 71 and a lock-pin is identified as 72. Seventy-three indicates the insulation gasket and 77 indicates the open-top cap. Finally a hypothetical bottle is given as 74.

FIG. 9 are schematics of all components of an accessory arm assembly.

FIG. 10 is an exploded view to illustrate the complete assembly of the liquid dispensing device.

FIG. 11 is also an exploded view to illustrate the liquid dispensing device coupled with the open-top cap, the insolation gasket, and the hypothetical bottle, aligned with the accessory arm assembly.

FIGS. 12 to 18 are schematics all together to illustrate the operational principle of the liquid dispensing device.

### DETAILED DESCRIPTION OF THE DRAWINGS

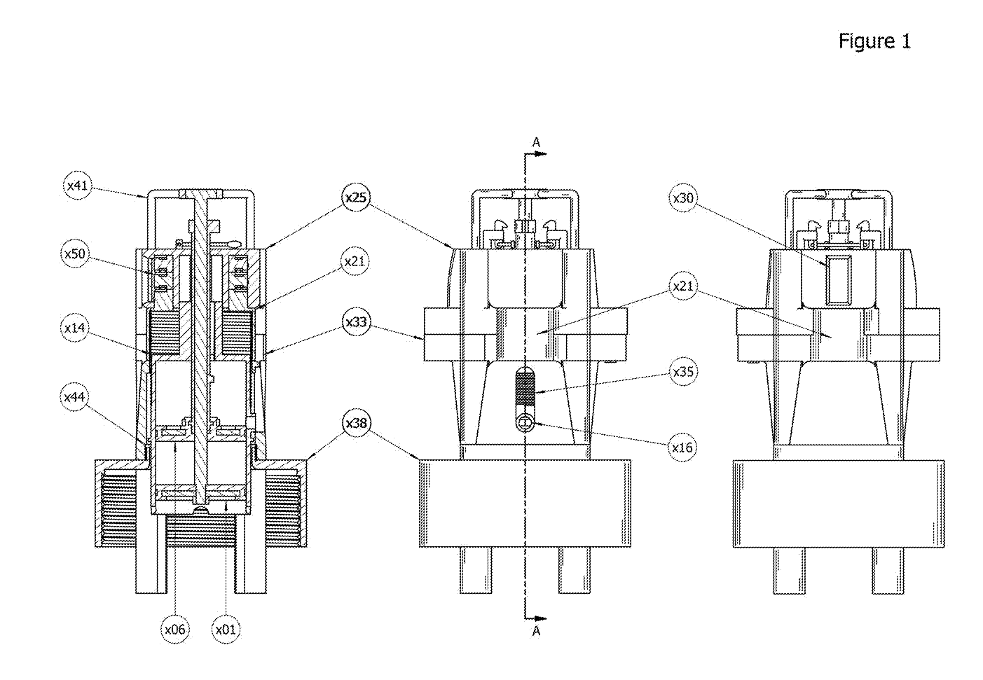

FIG. 1 presents from left to right: a sectional view, front and back views of the dispensing device in the previous submission (U.S. patent application Ser. No. 14/057,327). x01 and x06 represent Lower Plunger assembly and Upper Plunger assembly, respectively. They are unchanged from the current submission. The syringe x14 is identified and has been modified in the current submission. The external thread on the syringe x14 was removed and its engagement with a Center Dial Wheel x21 was replaced by a rotating-cap 41 and a hollow stud-bolt 51 in the current submission. Center Dial Wheel x21 is removed in the current submission. x25, x33 and x38 represent Cylinder Part 1, Part 2 and Part 3, and are no longer present in the current submission. x50 represents the Center Wheels that formed part of a micrometer. This is replaced in the current submission by peg-wheels 61. x41, representing Guide Rods that were bound to four springs near the proximal ends to provide elastic force is deleted in the current submission. An accessory arm assembly in the current submission takes on the role of the Guide Rods. The dispensing outlet x16 remains in the current submission. The view window x30 is modified in the current submission while the opening on Cylinder Part 2 for the dispensing outlet is no longer present in the current submission.

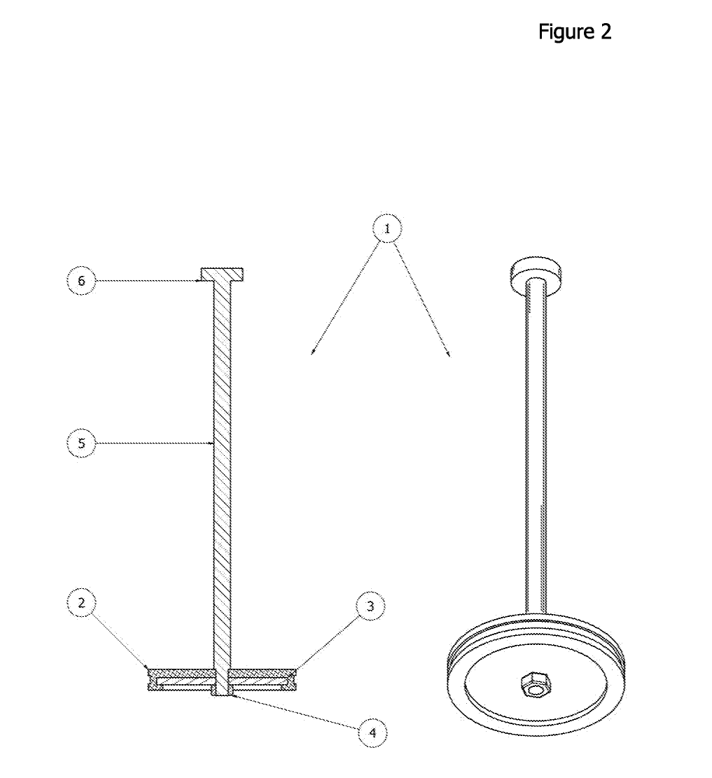

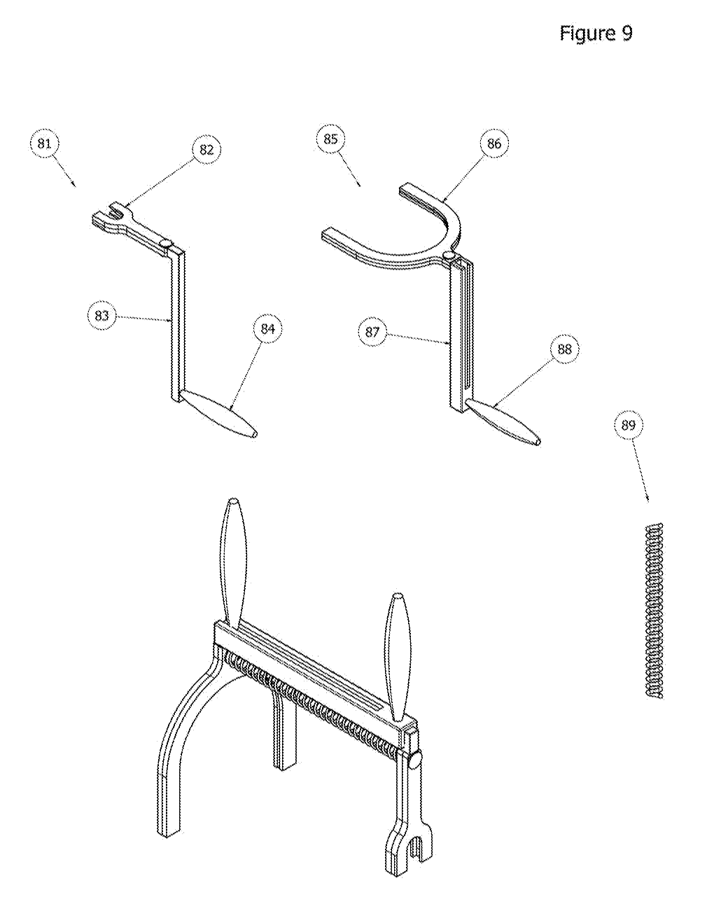

There are two panels in FIG. 2, a sectional view on the left and a projected view on the right, to illustrate the assembly of the lower-plunger 1. In plunger assembly, a plunger head 2 is made of a pliable material to maintain a liquid tight seal around its periphery. The plunger head 2 is strengthened by a disk 3 and is attached to an arm 5 from the front. The arm 5 is provided with a threaded stem at the end that passes through the plunger head 2 and is run by a nut 4 on its back to secure the joints between the end of arm and the head of lower-plunger and seal the potential leak of liquid from the joint. The distal end of the arm 5 is expanded to form a plate 6 which can be held by a human hand operating the device or is engaged by a clip 82 from a sliding latch 81 (FIG. 9) to drive the lower-plunger.

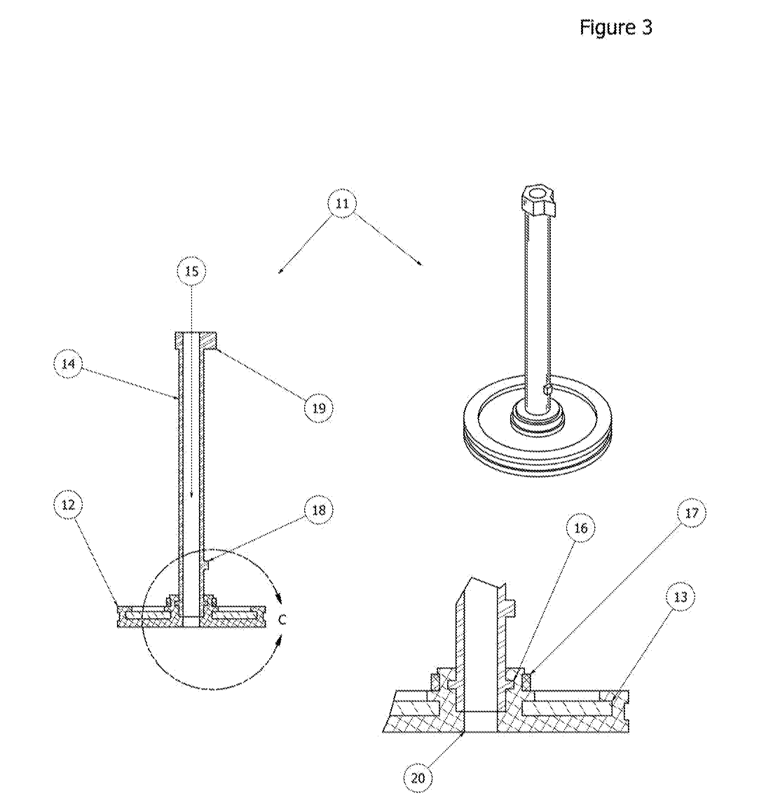

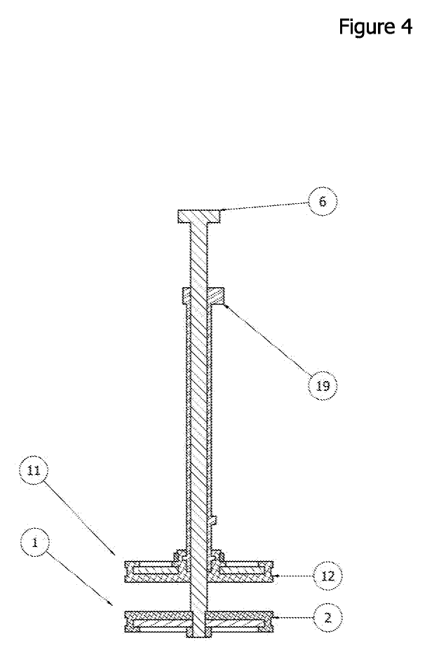

FIG. 3 also has several panels, a sectional view on the left panel, a projected view and a detailed view on the top-right and bottom-right panels, respectively, to depict the assembly of the upper-plunger 11. A plunger head 12 of the upper-plunger 11 is also made of the pliable material to maintain a liquid tight seal around periphery. The plunger head 12 is strengthened by a disk 13. The arm 14 of the upper-plunger 11 is hollow at the center 15 and does not insert throughout the entire layer of the plunger head 12 from the back, leaving the plunger head 12 to form a portion of the wall on the edge of the hole 20 (see the detailed view). The pliable material of the plunger head 12 maintains a liquid tight seal surrounding the central hole 15 where the arm 5 of the lower-plunger 1 passes through. The arm 14 of the upper-plunger 11 attaches to the plunger head 12 by an expanding ring 16 near the terminal of the arm 14 that is buried inside the plunger head 12. To secure the attachment, a circular ring 17 is placed outside plunger head 12 that surrounds the expanding ring 16. The lower portion of the arm 14, it is provided with a protruding block 18 and at the proximal end of the arm, there is a pointer 19. The protruding block 18 and the pointer 19 stand in the same orientation. Their function is associated with the syringe 21 and will be given in detail in FIG. 5.

The FIG. 4 illustrates the arrangement between the lower-plunger 1 and the upper-plunger 11. The center of the upper plunger is hollow and the arm of the lower-plunger slides through the upper-plunger freely along the axis, given the apposition of the plungers at one end, and the plate 6 and the pointer 19 at the other end. In this arrangement, the faces, defined here as the ‘front’ faces, for both are functioning to propel and dissipate the liquid trapped inside the syringe, of the plunger head 2 from the lower-plunger and the plunger head 12 from the upper-plunger are facing each other.

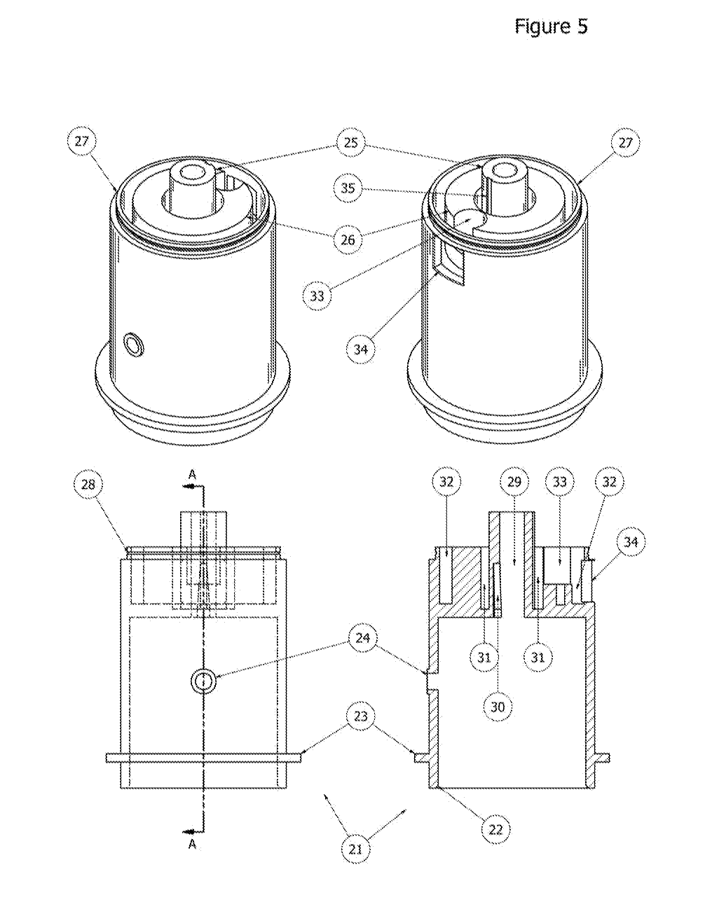

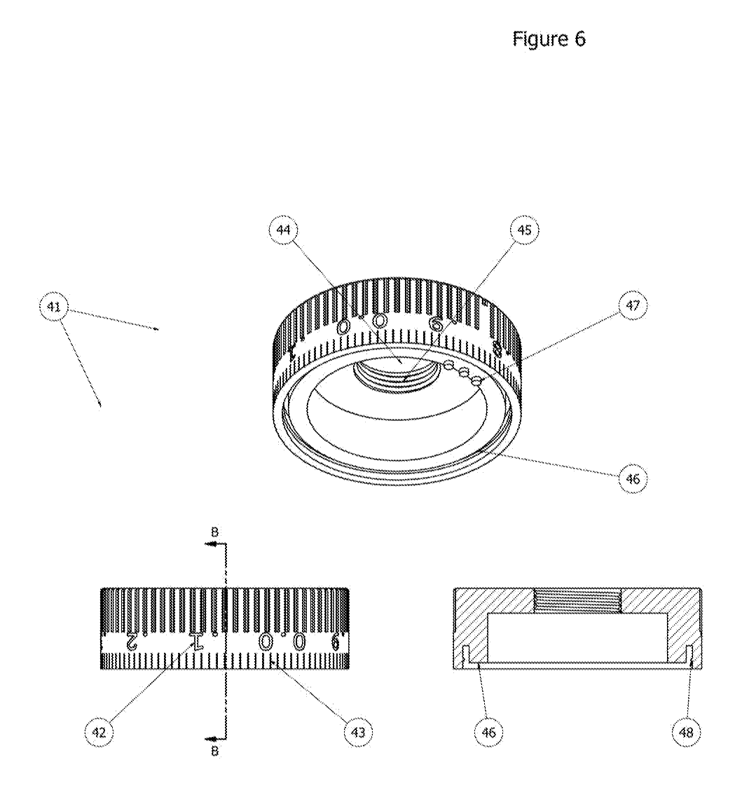

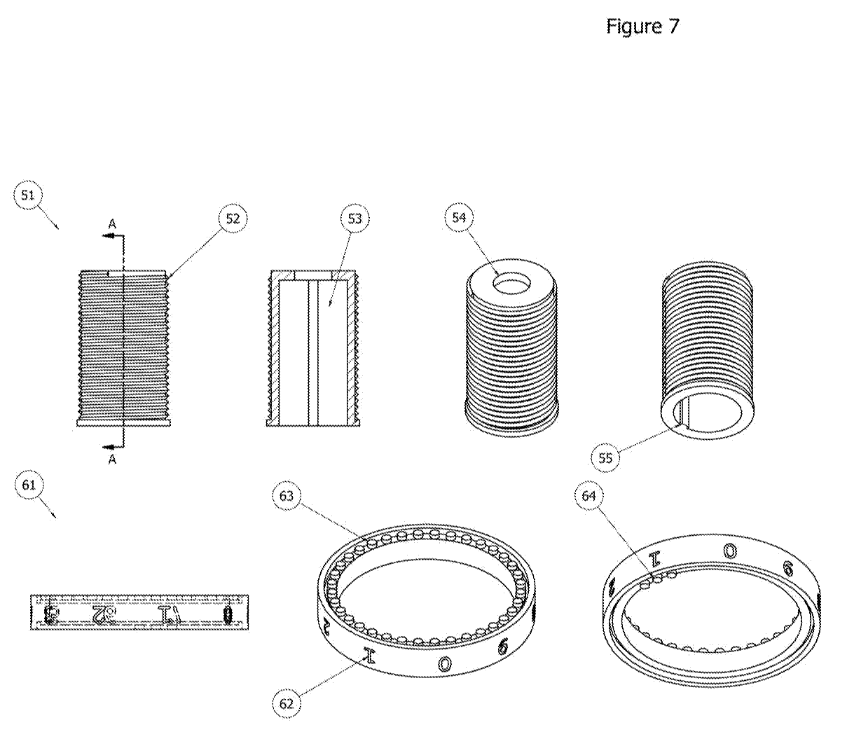

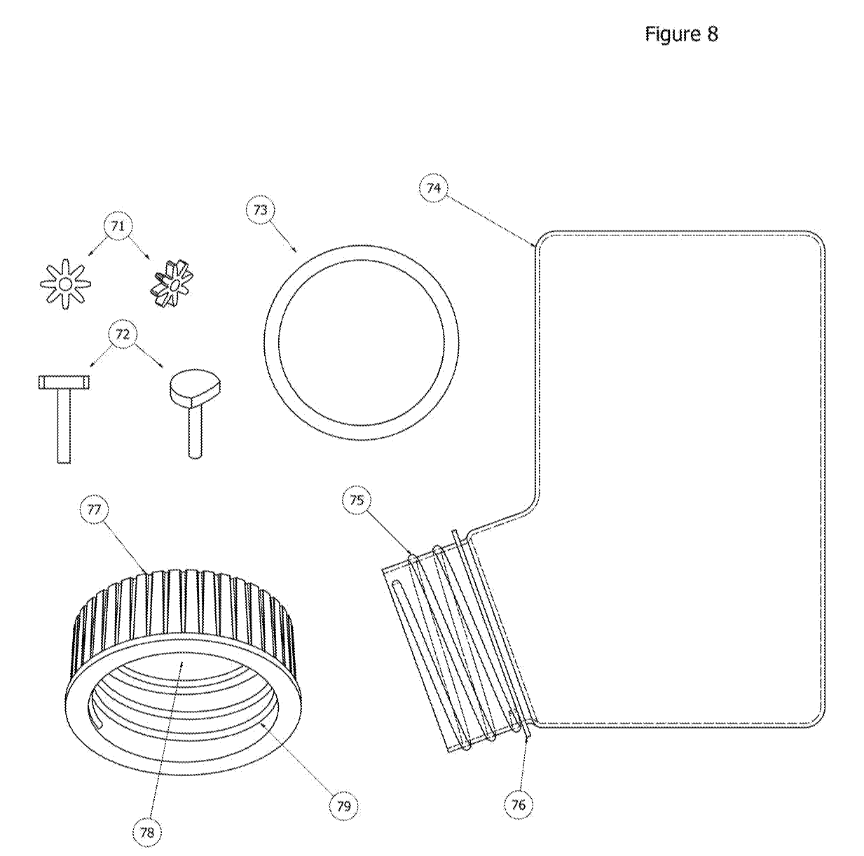

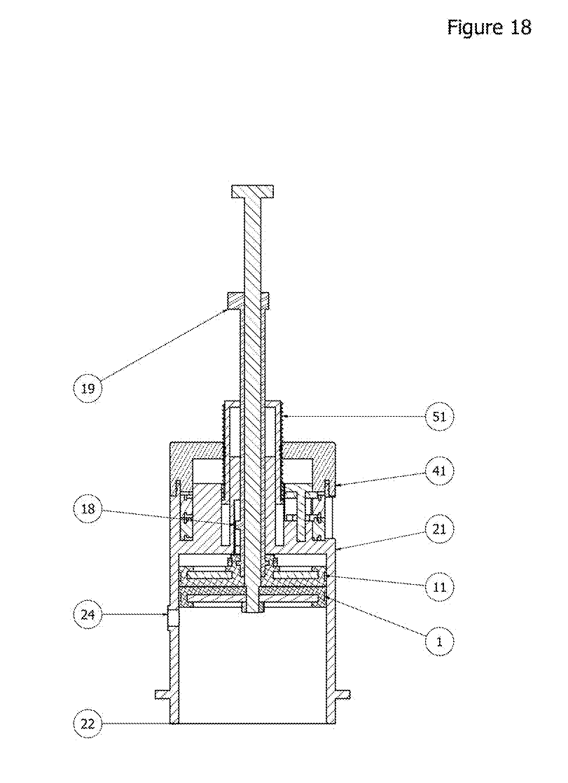

In FIG. 5, the two top panels are projected views of the syringe 21, the bottom-left panel is a front view and the bottom-right is a sectional view of the same object. The syringe has an open end 22 that contacts the liquid inside the container. The inside edge of the open end 22 is chamfered to form a sloping edge to facilitate the entry of the lower-plunger 1. At the outside surface on the barrel of the syringe, there is an expanding ring 23 and a dispensing outlet 24. The expanding ring 23 functions to sit on the bottle neck and when coupled with an insulation gasket 73 (FIG. 8) and open-top cap 77 (also FIG. 8), the expanding ring secures and seals the dispensing device to the opening of a liquid container. The diameter of the expanding ring is flexible, depending on the diameter of the opening on the liquid container. On the proximal end of the syringe, there are several protruding structures, a central column 25, a middle circular column 26, and an outside circular ring 27. The central column 25 has a central hole 29 in the middle that is for the passage of both arms of the upper-plunger 11 and the lower-plunger 1. A guide slot 30 is located on the wall of the central hole 29. The guide slot 30 is in the same orientation as the dispensing outlet 24 and is designed to host the protruding block 18 of the upper-plunger 11. As mentioned, the protruding block 18 and the pointer 19 of the upper-plunger (FIG. 3) also stand in the same orientation. Normally the central hole 29 prevents the upper-plunger 11 from moving further proximally by blocking the entry of the protruding block 18. But when the pointer 19 of the upper-plunger is in the same orientation as the dispensing outlet 24, the protruding block 18 will align with the guide slot 30. This allows both the upper-plunger 11 and lower-plunger 1 to travel further proximally to open the dispensing outlet entirely (see FIG. 18). On the outside wall of the central column 25, in the opposite orientation to the guide slot 30, there is a limiting slot 35. The limiting slot engages a limiting bar 55 that is protruding from the inside wall of the hollow stud-bolt 51 (see FIG. 7). The circular space between the central column 25 and middle circular column 26 is designated as 31. The hollow stud-bolt 51 fits in this space 31 and sits on top of the central column 25. The circular space between the middle circular column 26 and the outside circular ring 27 is designated as 32. Two peg-wheels 61 (FIG. 7) are placed in this space 32. The middle column 26 is cut by a hollow circular column 33 which cuts open to the space 32. The hollow circular column 33 will host two gears 71 (FIG. 8). In the same orientation as 33 and further outside, there is a window 34 on the outside circular ring 27. The operator can read the digits on the peg wheels 61 through this window 34 when setting the dispensing volume. On the cylindrical surface of the outside circular ring 27, there is an indented ring 28 on the wall that engages to a protruding ring 48 on the rotating-cap 41 (see FIG. 6).

FIG. 6 shows schematics of the rotating-cap 41. A projected view is in the top panel, and front and sectional views are in the bottom-left and bottom-right panels, respectively. The rotating-cap is engraved with digits 42 and markers 43 on its cylindrical surface. The top of the rotating cap has a threaded (45) hole 44. The thread 45 is engaged by the hollow stud-bolt 51 (FIG. 7). Inside the rotating cap, there is a circular ridge 46 protruding into the circular space 32 of the syringe 21 when the rotating cap covers the top of the syringe 21. There are three pegs 47 located on top of the circular ridge 46. The closure by the rotating-cap 41 of the top of the syringe 21 is secured by the protruding ring 48 on the rotating cap engaging the indented ring 28 on the outside circular ring 27 of the syringe.

FIG. 7 shows schematics of the hollow stud-bolt 51 (top panels) and the peg-wheel 61 (bottom panels). In the top panels from left to right, they are front, sectional and two projected views of the hollow stud-bolt 51. The hollow stud-bolt has a thread 52 on external cylindrical surface. The top of the hollow stud-bolt is open 54 to make passage for both arms of the upper-plunger 11 and the lower-plunger 1. Inside the barrel of the hollow stud-bolt there is a limiting bar 55 that is protruding from the cylindrical surface. The limiting bar 55 fits into the limiting slot 35 of the syringe to restrict the movement of the hollow stud-bolt. When the rotating-cap 41 turns, the hollow stud-bolt can only move axially, up or down. In the bottom panels from left to right, are a front view and two projected views of the peg-wheel 61. The peg-wheels fit into the circular space 32 between the middle circular column 26 and the outside circular ring 27 of the syringe (FIG. 5). There are digits 62 on the cylindrical surface that can be read through the view window 34 by users. There are 36 pegs 63 on the bottom surface and 3 pegs 64 on the top surface of the peg-wheel. Two peg-wheels are installed inside space 32 in the syringe 21 with the bottom surface of the peg-wheel that has 36 pegs facing proximity. The circular ridge 46 that has three pegs 47 of the rotating-cap also protrudes into the circular space 32 of the syringe. When they are engaged with two gears 71 (FIG. 8) that are installed inside the hollow circular column 33 of the syringe, every time the rotating-cap 41 makes a 360 degree full turn, the three pegs 47 turn the peg-wheel one digit at a time in the view window. In the current design, the high resolution volume adjustment is defined by the threads on the hollow stud-bolt 51 and rotating-cap 41 determining the number of revolutions per unit of height, with a full turn of the rotating cap corresponding to a one milliliter change in dispensing volume. For the lower resolution volume adjustment applications, one full turn by the rotating-cap could represent up to two or four milliliters. In these cases, instead of one group of three-aligned-pegs on the circular ridge of the rotating-cap and on the top surface of the peg-wheel, there can be two groups or four groups of three-aligned-pegs distributed evenly in the full circle.

FIG. 8 shows schematics of several miscellaneous components. The gear 71 which is placed in the hollow circular column 33 of the syringe and a lock-pin 72 which is used to constrain the gears and to cover the opening of the hollow circular column 33. The insulation gasket 73 and the open-top cap 77 are used to secure the syringe to the neck of a bottle. In this case, a hypothetical bottle 74 is given that has thread 75 at its opening and a flange 76 around the neck. The open-top cap 77 has an opening at top 78 and a thread 79 at the inside cylindrical surface.

FIG. 9 are schematics of an accessory arm assembly (bottom panel). The accessory arm assembly is composed of a sliding latch 81, a hosting latch 85 and a spring 89. The sliding latch contains a clamp 82 that fasteners to the plate 6 of the lower-plunger 1, a square sliding rod 83 and a handle 84. The hosting latch engages the sliding rod 83 inside the latch 87 and has a handle 88, and contains a clamp 86 that snaps on the flange 76 at the neck of the bottle 74. The spring 89 attaches to both the sliding latch and the hosting latch, and provide elastic force to drive to these parts towards each other.

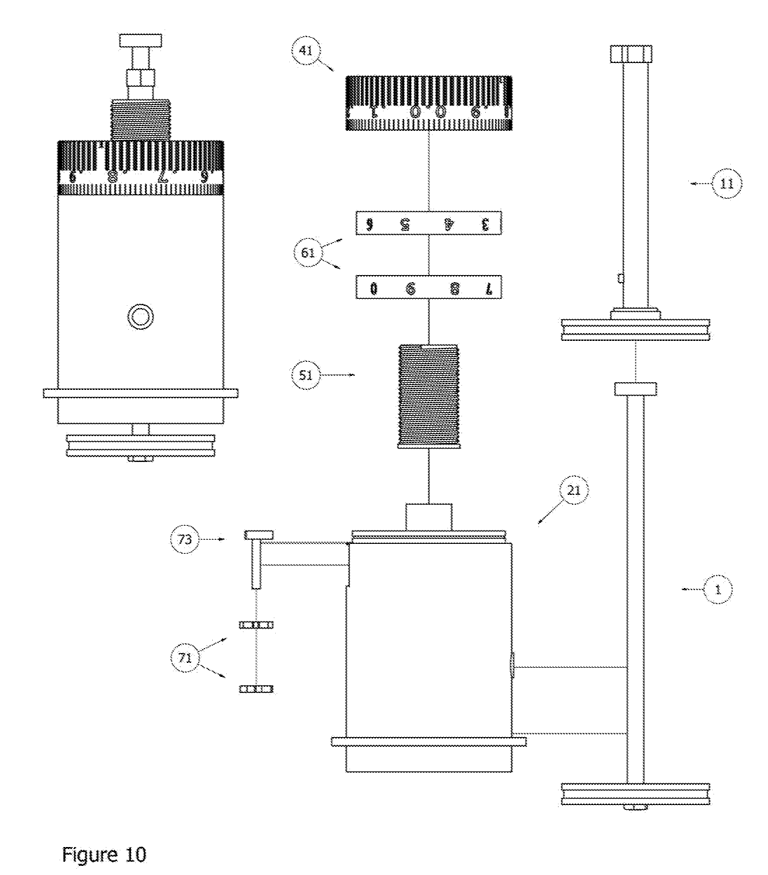

FIG. 10 illustrates the complete assembly of the liquid dispensing device that comprises the lower-plunger 1, the upper-plunger 11, the syringe 21, the rotating-cap 41, the hollow stud-bolt 51, the peg-wheels (two units) 61, the gears (two units) 71 and the lock pin 73. The front view of the liquid dispensing device is given in the top-left panel. The rest of the field is an exploded view of these components. The rotating-cap 41, two peg-wheels 61 and two gears 71 form a micrometer. As the rotating-cap makes one 360 degree full turn its three-aligned-pegs 47 engages with a gear to turn the first peg-wheel one digit at a time. Likewise, when top peg-wheel completes one 360 degree full turn its three-aligned-pegs 64 engage with a gear to turn the second peg-wheel one digit at a time.

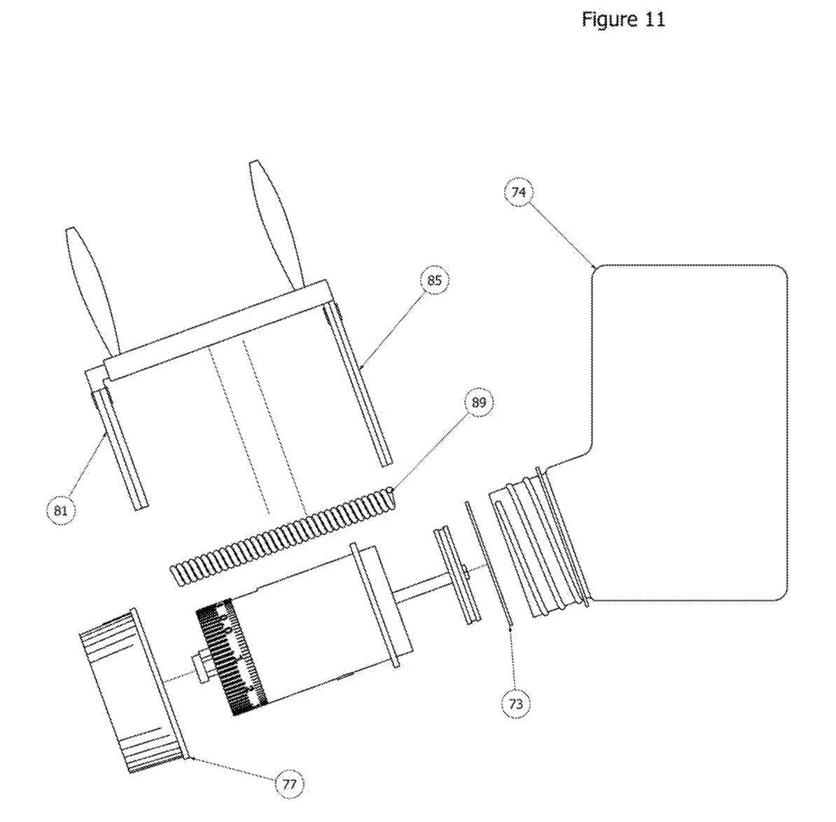

FIG. 11 illustrates the liquid dispensing device coupled with the open-top cap 77, the insolation gasket 73, and the hypothetical bottle 74, aligned with the accessory arm assembly, 81, 85 and 89 in an exploded view.

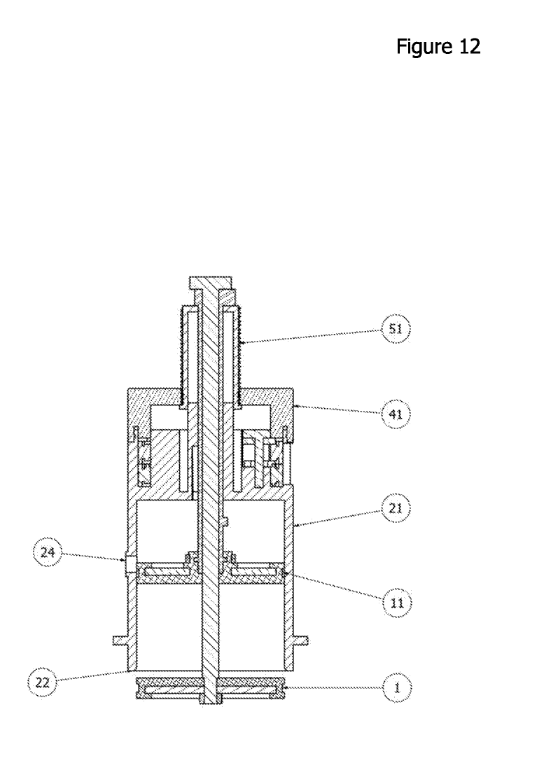

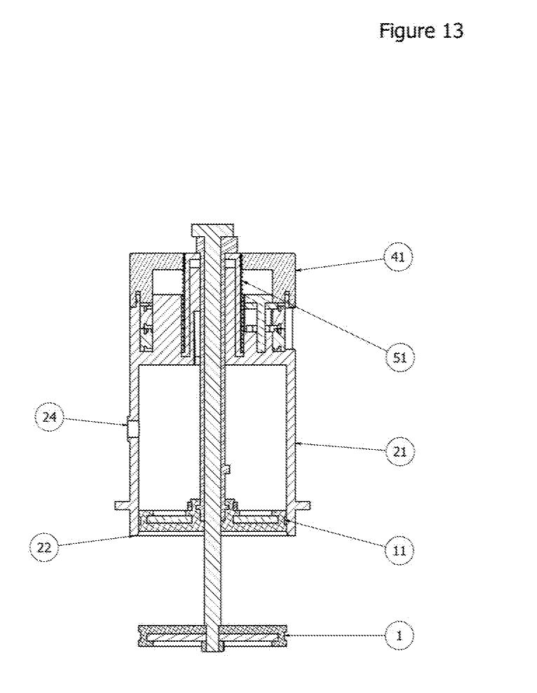

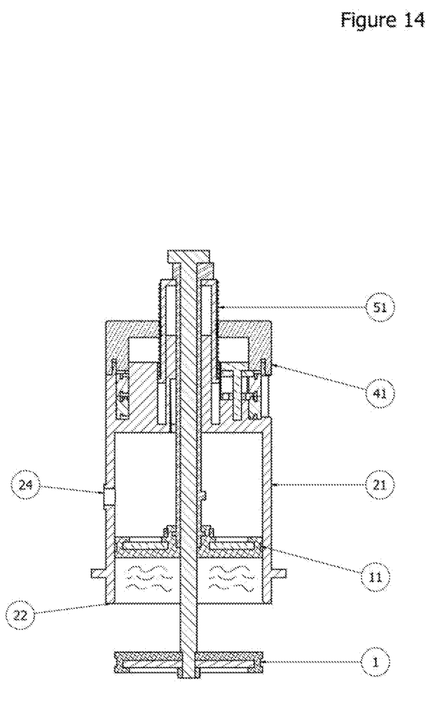

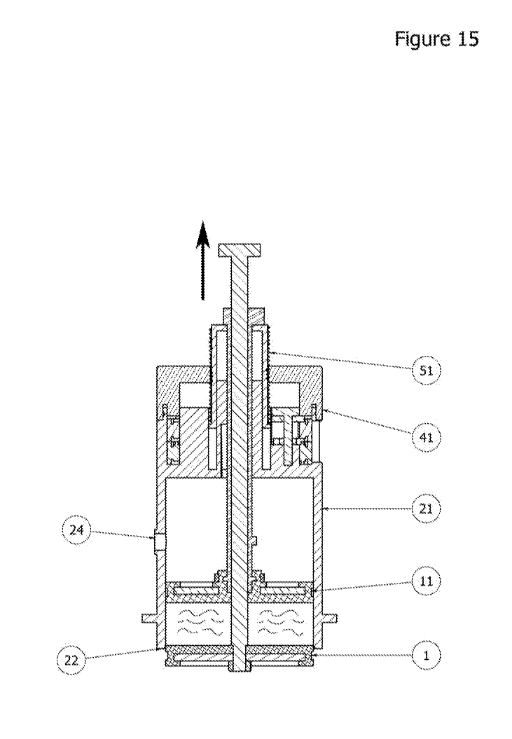

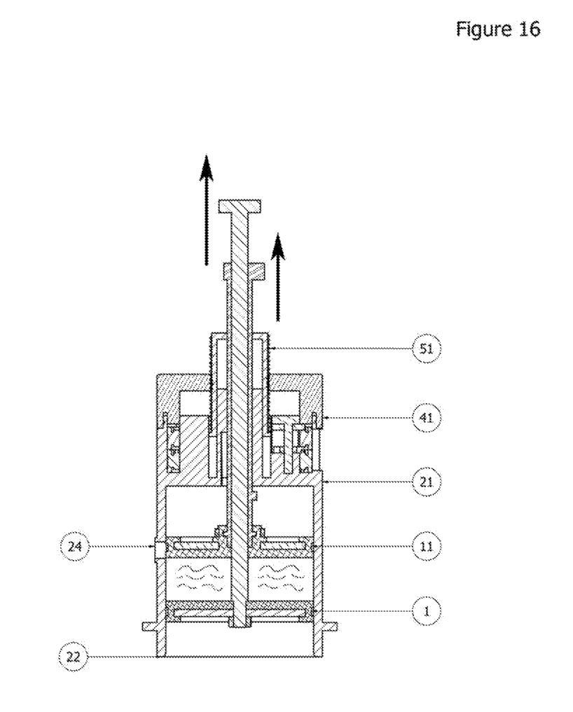

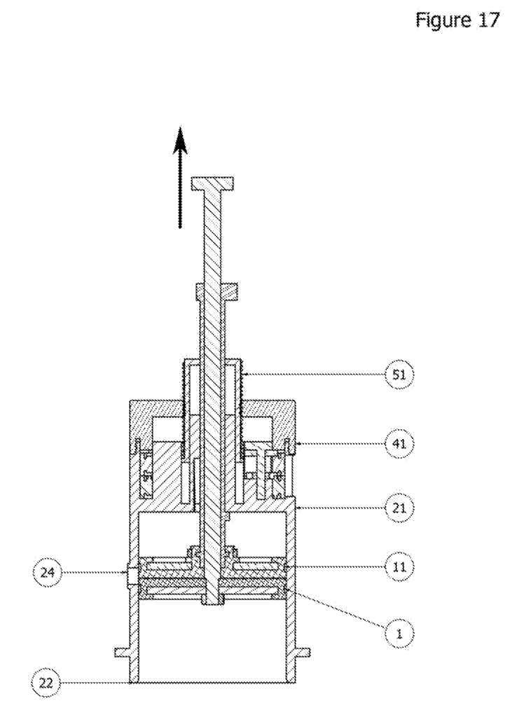

Now referring to FIGS. 12 to 17. Altogether these are schematics illustrating the operational principle of the liquid dispensing device. FIGS. 12 to 17 are sectional views of the same assembly given in FIG. 10. In FIG. 12 to FIG. 18, the lower-plunger 1, the upper-plunger 11, the syringe 21, the rotating-cap 41 and hollow stud-bolt 51 are identified. The open end 22 and the dispensing outlet 24 of the syringe are also identified. FIG. 12 represents a status ready for a maximal dispensing volume. The arm of the lower-plunger, along with the arm of upper-plunger, is pushed all the way into the device. The hollow stud-bolt is positioned at the most proximal end by the rotating-cap. A pocket space is formed inside the open end 22 of the syringe that is partitioned by the upper-plunger 11. Still in FIG. 12, the more proximally the hollow stud-bolt is positioned, the deeper the pocket space is formed by the syringe and the upper-plunger. Next, FIG. 13 represents a status ready for a minimal dispensing volume. In this case, the hollow stud-bolt is positioned in its most distal position and thus the pocket space formed between the syringe and upper-plunger is at a minimum. The more distally the hollow stud-bolt is positioned, the shallower the pocket space formed by the syringe and the upper-plunger. FIG. 14 represents a status prepared for an intermediate dispensing volume. The engagement between the rotating-cap and the hollow stud-bolt is midposition. An intermediate pocket space (see fluid marker) is formed. Next in FIG. 15, the lower-plunger is extracted from its distal position in FIG. 14. As the lower-plunger moves (see arrow), it seals the open end 22 of the syringe and traps a portion of liquid inside the pocket space. In FIG. 16, as the lower plunger continues to be withdrawn, hydraulic pressure forces the upper-plunger to move simultaneously towards the proximal end (see both arrows in FIG. 16). Forced outward movement of the upper-plunger stops when it reaches the opening of the dispensing outlet 24 and fluid begins to be expelled. Continued extraction of the lower plunger forces the liquid trapped inside the pocket to be completely expelled from the syringe as the plungers come into apposition (see FIG. 17). Also, shown in FIG. 17, the outward movement by the plungers will stop when the protruding block 18 on the upper plunger contacts the inner surface of the syringe 21.

FIG. 18 depicts an application in which liquid may be made to continuously flow out of liquid container, the user can turn the pointer 19 of the upper-plunger to align with the dispensing outlet 24, and the protruding block 18 of the upper plunger will be aligned with the guide slot 30 located on the wall of the central hole 29. Under this condition, both upper and lower plungers can be pulled further to lie proximal to the dispensing outlet 24, allowing a continuous flow from the liquid container.

To aliquot a precise volume from the liquid dispensing device, a person operating the device first turns the rotating-cap to set a specific dispensing volume. The dispensing volume is displayed on the view window. The person then pushes the arm of the lower-plunger all the way into the device. If the accessory arm assembly is equipped, the lower-plunger set at this position by default. Since the lower-plunger has a longer arm, the plunger head passes the open end of the syringe and opens the pocket space to fluid flow. The liquid fills the pocket space that is partitioned by the upper-plunger inside the barrel of the syringe. Next, the person pulls the arm of the lower plunger outwards, or the person presses both handles closer against the elastic force of the springs to pull the arm of the lower-plunger outwards (ultimately, this motion could be powered by a motor). As the lower-plunger travels back it seals the open end of the syringe, and a precise volume of liquid is now trapped inside the barrel of the syringe. As the lower-plunger travels further outwards, it pushes the upper-plunger to move along by the hydraulic pressure. The upper-plunger eventually stops when the dispensing outlet on the syringe is exposed to the liquid trapped inside the syringe. Trapped liquid will be released by the force of the lower-plunger. The dispensing process completes when two plungers make contact inside the syringe.

### EXAMPLES

Based on the notions to coordinate a lower plunger, an upper plunger and a syringe to extract and expel liquid from the syringe with precise and adjustable volume control, the current conformational structure can be modified but still keep the same principle and functions.

In the current conformation provided in this application, the adjustment of volume is carried out by a rotating-cap placed at the distal end of the syringe. As the rotating-cap turns the hollow stud-bolt moves up or down along the axis of the device. One modification is simply to add threads between syringe and rotating-cap for engagement and to omit the hollow stud-bolt to achieve the same result, i.e., one could turn the rotating-cap to move it up and down along the axis of the device when thread on the rotating-cap can run on the thread on the external of the syringe.

Another modification is to replace the threads between the rotating-cap and hollow stud-bolt with parallel and discontinuous rings, i.e., the layers of repeated small ridges and ditches. So that instead of turning the rotating-cap, one can simply push or pull the hollow stud-bolt in and out one step or a few steps at a time. Under this configuration, the dispensing volume is adjusted incrementally, e.g. 0.2 milliliter increase or decrease at a time.

Based on the principle of combining one syringe and two plungers together, another modification is that instead of moving the lower-plunger up and down to extract liquid, one can push and pull the syringe to achieve liquid dispensing. The lower-plunger can be placed inside the liquid container steadily during the operation. The relative position of the upper-plunger and the syringe is adjusted and then locked. When the relative position of the upper plunger and the syringe is set, and the pocket space is formed, the syringe is first pulled away from the lower-plunger to open the pocket space to the liquid. After flooding the pocket space with liquid, the syringe is pushed towards the lower-plunger. This will seal the pocket space and then further expel the liquid from the pocket space when the upper-plunger and the lower-plunger move closer.

Lastly, one can also adapted into our previous conformation with threads on the body of syringe and a dial-wheel as detailed in the prior submission (U.S. patent application Ser. No. 14/057,327). This conformation is cumbersome but it works well to achieve a precise and adjustable dispensing volume.

What claimed is:

1. A liquid dispensing device mounted underneath a liquid container comprising:
(a) a syringe having a dispensing outlet on the barrel, a distal chamfered end in direct contact with the liquid inside the container, and a proximal end containing a central hole;
(b) a lower-plunger having an arm attached to the front that propels liquid;
(c) an upper-plunger having an arm attached to the rear and a central hole throughout the upper-plunger; and
(d) a rotating-cap means having a thread that runs on the thread of a hollow stud-bolt means for setting the dispensing volume; and
wherein the lower-plunger and the upper-plunger are arranged with the arm of the lower-plunger to pass through the upper-plunger and with the front side of both plungers facing each other, and
wherein the upper-plunger and the syringe are arranged with the arm of the upper-plunger to pass through the central hole of said syringe, and
wherein the rotating-cap is situated at the proximal end of the syringe, and
whereby the rotating-cap means and the hollow stud-bolt means are engaged for setting the axial position of the hollow stud-bolt, and
whereby the relative position of the upper-plunger inside the syringe is set, and
whereby the syringe, the upper-plunger and the lower-plunger are engaged to open the distal end of the syringe and to partition a pocket space inside the syringe to be filled with liquid from the end of the syringe now open, and
whereby the lower-plunger converges towards the upper-plunger to seal and to enter the open end of the syringe and then to dissipate the liquid trapped inside the pocket space from the dispensing outlet on the barrel of the syringe.

2. The liquid dispensing device of claim 1, wherein the adjustment of dispensing volume is achieved by the rotating-cap having an internal thread to run on the external thread of the hollow stud-bolt to bring about changes of the relative position between said syringe and said upper-plunger and to bring about changes of the dispensing volume.

3. The liquid dispensing device of claim 1, wherein said syringe has an expanding ring on the barrel of the syringe.

4. The liquid dispensing device of claim 1, wherein the head of said lower-plunger is made of a pliable material to maintain a liquid tight seal around periphery and central hole, and the arm of said lower-plunger is jointed to the head of said lower-plunger by a nut that runs on the threaded stem protruded from the arm of said lower-plunger.

5. The liquid dispensing device of claim 1, wherein the arm of said upper-plunger does not insert through the entire layer of the plunger head from the back to have the pliable material to form a portion of wall of the central hole of said upper-plunger.

6. The liquid dispensing device of claim 1, wherein the front faces of said upper-plunger and said lower-plunger are aligned and facing each other and coordinately extract and expel liquid from said syringe.
